(19) United States
(12) Patent Application Publication
(10) Pub. No.: US 2012/0047284 A1
(43) Pub. Date: Feb. 23, 2012

(54) Data Transmission Optimization

(75) Inventor: Sasu Tarkoma, Helsinki (FI)

(73) Assignee: NOKIA CORPORATION, Espoo (FI)

(21) Appl. No.: 13/318,345

(22) PCT Filed: Apr. 30, 2009
(86) PCT No.: PCT/FI09/50347

§ 371 Date: Oct. 31, 2011

(51) Int. Cl. G06F 15/16; H04L 29/06; G06F 17/30

(52) U.S. Cl. 709/247

(57) ABSTRACT

The invention relates to data transmission and updating data from one location to another. The invention offers methods, apparatuses and computer programs for forming client data chunks corresponding to server data chunks, for forming client digests and a parent client digest, for sending the parent client digest to a server, and in response to the sending of the parent client digest, for receiving instructions from the server for forming a client data item, and for forming the first client data item at the client using the client data chunks.

### FIELD OF THE INVENTION

The present invention relates to data transmission systems, and more particularly to improving the data transmission through compression.

### BACKGROUND OF THE INVENTION

The delivery of very large data sets is commonplace on today's Internet. For example, software updates, video-on-demand and peer-to-peer downloads of files typically involve data and files whose size can range from a few megabytes to several gigabytes or more. Moreover, the use and download of large data files like video and music over the internet is becoming more and more common among consumers.

Today's Internet has evolved a lot from the early days of the network, and the development of fast data transmission technologies for the consumer have made this possible. It is very commonplace for a consumer to have a fixed internet connection whose speed is in the order of megabits per second. Such speeds already allow the viewing or download of video files, easy download of music, having a data storage on the Internet, transmitting large files over e-mail and many other useful services for the consumer. All these services have been made possible by significantly faster fixed connections than what were available 10 years ago—a good connection in the last decade would be a connection of a few hundred kilobits per second.

There are more than four billion devices allowing mobile communication in the world today. At their fastest, the connection speed of these devices to the Internet is of the order of a few megabits per second, which already allows the same kind of useful services that have become commonplace over the fixed internet. However, the speed of the mobile networks can be clearly smaller e.g. in rural areas. The mobile communication devices can have a large memory space available for the users desired content. The memory capacity of a multimedia-enabled mobile communication device (e.g. a smartphone) can be more than 10 gigabytes.

Receiving data to the user device from the network and transmitting data to the network therefore requires efficient solutions. One technology that may help in the data transmission is caching, where a file that already exists in the device is not sent again from the network to the device. Caching technology is commonplace in internet browsers today. Another technology that may help in transmission of files is data synchronization technology such as SyncML. Data synchronization generally allows to retransmit only those files to the device that have been changed or created (so-called fast synchronization) after a previous synchronization (which may be a so-called slow synchronization). Yet another technology that may help in transmission of files is so called binary delta compression, where only the changed part of a file is transmitted. Unfortunately, these existing technologies are of little help regarding transmission speed in many situations such as where large new files need to be transmitted from the network to the user device, since according to these existing technologies, complete new files need to be transmitted. These existing technologies may also suffer from other shortcomings like significant processing overhead.

There is, therefore, a need for a solution that would alleviate the challenges where large files or large amounts of data need to be transmitted between the network and the user device, or between different user devices, or between different network elements.

### SUMMARY OF THE INVENTION

Now there has been invented an improved method and technical equipment implementing the method, by which the above problems are alleviated. Various aspects of the invention include a method, an apparatus, a server, a client and a computer readable medium comprising a computer program stored therein, which are characterized by what is stated in the independent claims. Various embodiments of the invention are disclosed in the dependent claims.

According to a first aspect, there is offered a method for data transmission at an apparatus using a first data connection. The method comprises forming at least a first client data chunk and a second client data chunk in the memory of the apparatus, wherein the first client data chunk corresponds to a first server data chunk and the second client data chunk corresponds to a second server data chunk, forming a first client digest for the first client data chunk in the memory of the apparatus, forming a second client digest for the second client data chunk in the memory of the apparatus, forming a parent client digest indicative of the first client digest and the second client digest in the memory of the apparatus, sending the parent client digest to a server, in response to the sending of the parent client digest, receiving instructions from the server for forming a first client data item using the first client data chunk and the second client data chunk, and forming the first client data item in the memory of the apparatus using the first client data chunk and the second client data chunk.

According to an embodiment, the method further comprises selecting the first client data chunk using a chunk selection function, wherein the chunk selection function is common for the server and the client.

According to an embodiment, the method further comprises making the first client data chunk and the first server data chunk correspond to each other over a second data connection prior to receiving the parent client digest at the server, wherein the second data connection is faster than the first data connection.

According to an embodiment, the method further comprises forming a plurality of parent client digests using a plurality of client digests in the forming of each parent client digest, and sending the plurality of parent client digests to the server using a digest negotiation protocol.

According to a second aspect, there is offered an apparatus comprising a processor and memory. The memory of the apparatus includes computer program code, and the memory and the computer program code are configured to, with the processor, cause the apparatus to form at least a first client data chunk and a second client data chunk in the memory of the apparatus, wherein the first client data chunk corresponds to a first server data chunk and the second client data chunk corresponds to a second server data chunk, to form a first client digest for the first client data chunk in the memory of the apparatus, to form a second client digest for the second client data chunk in the memory of the apparatus, to form a parent client digest indicative of the first client digest and the second client digest in the memory of the apparatus, to provide the server with access to the parent client digest, in response to the providing of the access to parent client digest, to receive instructions from the server for forming a first client data item using the first client data chunk and the second client data chunk, and to form the first client data item in the memory of the apparatus using the first client data chunk and the second client data chunk.

According to an embodiment, the apparatus further comprises computer program code configured to, with the processor, cause the apparatus to select the first client data chunk using a chunk selection function, wherein the chunk selection function is common for the server and the client.

According to an embodiment, the apparatus further comprises computer program code configured to, with the processor, cause the apparatus to monitor the access of the first client data chunk to form first access monitoring information, and to modify the chunk selection function based on the first access monitoring information.

According to an embodiment, the apparatus further comprises computer program code configured to, with the processor, cause the apparatus to modify the chunk selection function to select larger chunks if the access monitoring information indicates frequent access.

According to an embodiment, the apparatus further comprises computer program code configured to, with the processor, cause the apparatus to make the first client data chunk in the memory of the apparatus and the first server data chunk correspond to each other over a second data connection prior to receiving the parent client digest at the server, wherein the second data connection is faster than the first data connection.

According to an embodiment, the apparatus further comprises computer program code configured to, with the processor, cause the apparatus to compute the first client digest, the second client digest and the parent client digest using a hash function, and to form a directed acyclic graph representation of the first client digest, the second client digest and the parent client digest.

According to a third aspect, there is offered a method for data transmission at an apparatus using a first data connection. The method comprises forming at least a first server data chunk and a second server data chunk, wherein the first server data chunk corresponds to a first client data chunk and the second server data chunk corresponds to a second client data chunk, forming a first server digest for the first server data chunk in the memory of the apparatus, forming a second server digest for the second server data chunk in the memory of the apparatus, forming a parent server digest indicative of the first server digest and the second server digest in the memory of the apparatus, receiving a parent client digest originating from a client, comparing the parent client digest and the server client digest, in response to the comparing, providing the client with access to instructions for forming a first client data item using the first client data chunk and the second client data chunk.

According to an embodiment, the method further comprises forming a plurality of parent server digests using a plurality of server digests in the forming of each parent server digest, and receiving a plurality of parent client digests originating from a client using a digest negotiation protocol.

According to an embodiment, the method further comprises selecting the first server data chunk using a chunk selection function, wherein the chunk selection function is common for the server and the client.

According to an embodiment, the method further comprises monitoring the access of the first server data chunk to form first access monitoring information, and providing access to the first server data chunk for the client based on the first access monitoring information.

According to a fourth aspect, there is offered an apparatus comprising a processor and memory. The memory of the apparatus includes computer program code configured to, with the processor, cause the apparatus to form at least a first server data chunk and a second server data chunk, wherein the first server data chunk corresponds to a first client data chunk and the second server data chunk corresponds to a second client data chunk, to form a first server digest for the first server data chunk in the memory of the apparatus, to form a second server digest for the second server data chunk in the memory of the apparatus, to form a parent server digest indicative of the first server digest and the second server digest in the memory of the apparatus, to receive a parent client digest originating from a client, to compare the parent client digest and the server client digest, and, in response to the comparing, to provide the client with access to instructions for forming a first client data item using the first client data chunk and the second client data chunk.

According to an embodiment, the apparatus further comprises computer program code configured to, with the processor, cause the apparatus to select the first client data chunk using a chunk selection function, wherein the chunk selection function is common for the server and the client.

According to an embodiment, the apparatus further comprises computer program code configured to, with the processor, cause the apparatus to monitor the access of server data to form first access monitoring information, and to modify the chunk selection function based on the first access monitoring information.

According to an embodiment, the apparatus further comprises computer program code configured to, with the processor, cause the apparatus to form a plurality of parent client digests using a plurality of client digests in the forming of each parent client digest, and to send the plurality of parent client digests to the server using a digest negotiation protocol.

According to an embodiment, the apparatus further comprises computer program code configured to, with the processor, cause the apparatus to form the plurality of parent client digests comprising a first parent client digest and a second parent client digest, wherein both the first parent client digest and the second parent client digest relate to the first client data item, and to use at least partly different client digests in the forming of the first parent client digest than in the forming of the second parent client digest.

According to an embodiment, the apparatus further comprises computer program code configured to, with the processor, cause the apparatus to compute the first server digest, the second server digest and the parent server digest using a hash function, and to form a directed acyclic graph representation of the first server digest, the second server digest and the parent server digest.

According to a fifth aspect, there is offered a computer program product stored on computer readable medium comprising computer program code that is configured to, when executed on a processor, cause an apparatus to form at least a first client data chunk and a second client data chunk in the memory of the apparatus, wherein the first client data chunk corresponds to a first server data chunk and the second client data chunk corresponds to a second server data chunk, to form a first client digest for the first client data chunk in the memory of the apparatus, to form a second client digest for the second client data chunk in the memory of the apparatus, to form a parent client digest indicative of the first client digest and the second client digest in the memory of the apparatus, to provide the server with access to the parent client digest, in response to the providing of the access to parent client digest, to receive instructions from the server for forming a first client data item using the first client data chunk and the second client data chunk, and to form the first client data item in the memory of the apparatus using the first client data chunk and the second client data chunk.

According to a sixth aspect, there is offered a computer program product stored on computer readable medium comprising computer program code that is configured to, when executed on a processor, cause an apparatus to form at least a first server data chunk and a second server data chunk, wherein the first server data chunk corresponds to a first client data chunk and the second server data chunk corresponds to a second client data chunk, to form a first server digest for the first server data chunk in the memory of the apparatus, to form a second server digest for the second server data chunk in the memory of the apparatus, to form a parent server digest indicative of the first server digest and the second server digest in the memory of the apparatus, to receive a parent client digest originating from a client, to compare the parent client digest and the server client digest, and, in response to the comparing, to provide the client with access to instructions for forming a first client data item using the first client data chunk and the second client data chunk.

The different aspects and embodiments of the invention offer several advantages. The communication of the parent digests enables reduced data communication between the server and the client. The forming of a plurality of parent digests enables the most efficient data compression to be selected. The monitoring of access information allows to improve the data compression by selecting the formation of parent digests in an optimal manner. The use of a fast data connection in making the data chunks at the server and at the client to correspond to each other enables to communicate the bulk of data using a fast connection, and communicating smaller amount of data comprising the digests using a possibly slower connection.

### DESCRIPTION OF THE DRAWINGS

In the following, various embodiments of the invention will be described in more detail with reference to the appended drawings, in which

FIG. 1a shows a system employing remote differential compression in updating a data file, where the system uses MD4 hashes to identify data chunks;

FIG. 1b shows a system and devices according to an embodiment where a mobile device is in operative connection with at least one server, and data can be transferred according to the embodiment between these devices;

FIG. 2 shows a system and devices according to an embodiment where preloaded data sets are used in compression of the data transmission;

FIG. 3 shows a method for compressing data communication according to an embodiment using preloaded data sets and data set identifiers or digests;

FIG. 4 shows a method, system and devices according to an embodiment where compressed web browsing communication is enabled by using preloaded data sets and sending request from the web client using compression with the help of data set identifiers or digests;

FIG. 5 shows a method, system and devices according to an embodiment where compressed web browsing with the help of data set identifiers or digests is enabled with the additional feature of enabling data set updates if frequent activity that cannot be compressed is detected;

FIG. 6 shows a method, system and devices according to an embodiment where compressed web browsing with the help of data set identifiers or digests is enabled with the additional feature of using a proxy for detecting malware with the help of malicious signatures from a trusted source;

FIG. 7 shows a method, system and devices according to an embodiment where compressed data transmission with the help of data set identifiers or digests is enabled by the way of a data-centric router that routes requests from a client to a server that has advertised compressed signatures to the router;

FIG. 8 shows the forming of a digest tree according to an embodiment, where data blocks B1-B5 are represented by digests or hash values and these digests or hash values are formed into an acyclic directed graph or a tree structure by forming further digests of at least two child digests and where all blocks B1-B5 are represented by a single root hash or a parent digests;

FIG. 9 shows a diagram for preloading data to a device according to an embodiment via a high-speed link;

FIG. 10 shows a diagram for simplified operation according to an embodiment where data transmission is compressed by way of using preload signatures;

FIG. 11 shows a method for forming a data item at the client according to an embodiment where data set identifiers or digests are used to identify existing data at the client and the existing data at the client is used to form the desired data item;

FIG. 12 shows a method for comparing a client digest tree to a server digest tree with the help of a parent client digest and a parent server digest;

FIG. 13 shows a schematic operation of a chunk selection function according to an embodiment;

FIG. 14 shows a method for updating a digest or hash tree based on frequency of access of the data chunks that the digests in the tree represent and informing the parties of data transmission of this updating;

### DETAILED DESCRIPTION OF THE EMBODIMENTS

In the following, several embodiments of the invention will be described in the context of data transmission between two devices over a network. It is to be noted, however, that the invention is not limited to network environments, but can be implemented in other environments, as well, such as any environments where two devices are in data connection with each other and inside a single device where two elements of the single device are in data connection with each other. In fact, the different embodiments have applications widely in any environment where optimization of data transmission is required.

One of the problems the embodiments seek to alleviate is to reduce data transmission costs by reducing the number of bytes transmitted, the required delivery time and the processing overhead. The problem is relevant for devices that operate at the edge of the network, for example wireless and mobile communication devices. Different embodiments are motivated by the fact that storage capacity is evolving faster than wireless data transmission rates. This means that by storing sufficient amount of data at the mobile device out-of-band, and being able to inform a server about this data, compression of data can be performed by relying on this out-of-band shared information. This benefits also processing requirements, since only the compressed fragments are encrypted and signed.

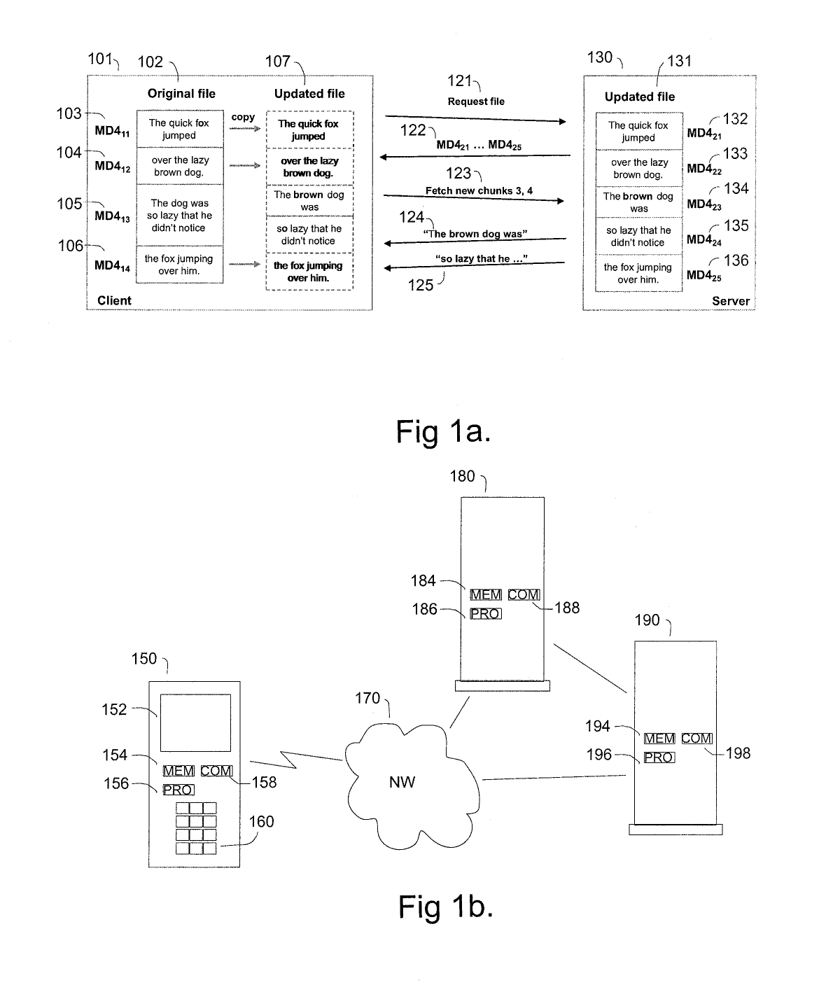

FIG. 1a shows one possible way of reducing data transmission costs between a client 101 and a server 130. The client 101 has an original file 102 stored in its memory. The original file consists of four sections that can be represented by so-called digests or hash values 103-106, in this case computed using the well-known MD4 algorithm. The server 130 has an updated file 131 stored in its memory, consisting of five sections that can be represented by hash values 132-136. This updated file 131 has been formed by modifying the original file 102 by replacing one element with two updated elements. The client 101 seeks to update its original file 102 to the updated version 107 that is identical to the version 131 of the file stored on the server. In order to achieve this, the client 101 sends a request 121 to the server. The server responds by sending the digests or hash values 132-136 of the sections of the file in a message 122. The client 101 compares the hash values 132-136 sent by the server to the hash values 103-106 it has in its own memory. The client detects that the hash values 103 and 132, the hash values 104 and 133 and the hash values 106 and 136 are identical, and also that it does not hold the data corresponding to the server hash values 134 and 135. It therefore requests the data chunks corresponding to the hash values 134 and 135 from the server in a message 123. The server sends the data chunks in a message 124 to the client, and the client is able to construct the updated file.

In the operation of FIG. 1a, the server returns the hash values or other signatures or digests 132-126 as a response to the client's request 121 to send data. The client has to first find similar files or data chunks locally before it can request the missing chunks from the server. This puts computational burden on the client as well as requires the server to send the hash values for the data chunks to the client, requiring data transmission capacity.

FIG. 1b illustrates a system and devices according to an embodiment. The system comprises a device 150, possibly a mobile terminal at the use of an end-user, and in connection to the network NW 170, and servers 180 and 190 in connection to the network NW 170. The devices can be either in fixed connection or in mobile connection with the network NW such as GPRS, UMTS, WLAN, Bluetooth, 10 Mbit/s, 100 Mbit/s or Gigabit ethernet or other wireless or wired data communication protocols. The device 150 may comprise a display 152 for displaying information to the user, memory 154 for storing data, a processor 156 for processing data, communication module 158 for connecting to the network 170 and for sending and receiving information, and a keyboard 160 for receiving input from the user. The server 180 may comprise memory 184 for storing data, a processor 186 for processing data, and a communication module 188 for connecting to the network 170 and for sending and receiving information. The server 190 may comprise memory 194 for storing data, a processor 196 for processing data, and a communication module 198 for connecting to the network 170 and for sending and receiving information. The devices 150, 180 and 190 comprise memory for storing data and they are able to send messages and data between each other via the network 170.

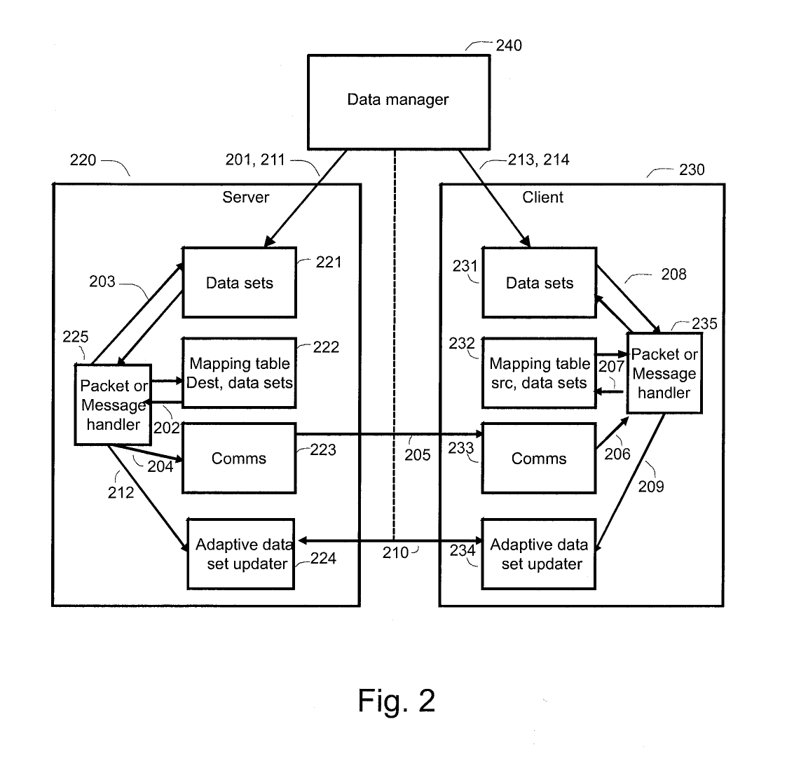

FIG. 2 presents a system of devices and their interactions according to an embodiment. The system comprises a server 220 and a client 230, and possibly a data manager or a content server 240. These devices can be physically separate and connected by a data network or they can be partially or wholly contained in one device and interacting using an internal data communication structure such as a bus or serial or parallel data communication means for inter-device communication. The server 220 may contain a packet or message handler 225, a communications module 223, memory for storing data sets 221 and memory for storing mapping data 222 relating data and digests computed from the data. The server may also contain an adaptive data set updater 224 that enables the server to update data sets 221 as necessary. The client 230 may contain a packet or message handler 235, a communications module 233, memory for storing data sets 231 and memory for storing mapping data 232 relating data and digests computed from the data. The server may also contain an adaptive data set updater 234 that enables the server to update data sets 231 as necessary. The data manager 240 may contain functionality to enable it to communicate with the client 230 and the server 220, and it may contain memory to store data for updating the data sets 221 and 231. In an operation according to an embodiment as presented in FIG. 2, there may be the following phases or steps. In steps 201 and 213 the data sets 221 and 231, correspondingly, are loaded with data from the data manager 240. This may happen through the use of a high-speed data link that is a different data connection than what normally exists between the data manager 240, the server 220 and the client 230 or some of these devices, or it may be the same data connection that normally exists between these devices. Using a fast data connection allows to download a large amount of data in steps 201 and 213. When the server 220 needs to send data to the client 230 in a compressed form, it first finds 202 data set identifiers or digests or signatures for the destination (the client). It then chooses suitable data set or sets 203 for compression and compresses the data to be sent using these data sets and their corresponding digests. It then uses 204 the communications means 223 to transmit 205 the compressed data to the client communications means 233 to be handled 206 by the message handler 235. The client then finds 207 data set digests (signatures) for sender and consults the digests in incoming data. After this, the client decompresses 208 the data using the data sets 231.

The server 220, the client 230 or the data manager 240 may also monitor 209 212 the used data sets with the help of adaptive data set updaters 224 and 234 (at the source or at the destination) and if there is frequent activity pertaining to certain domain or service, it may check if a data set is available for compression. If the data set is available, the system may load new data sets 210 using, and it may even use compression for the transmission of the new data set. In this monitoring, the data sets 221 and/or 231 may also be kept the same and new data set compositions and reference skeletons data access frequency may be created. The system may thus support updates to the reference skeletons (new digest structures) that better reflect frequent interaction patterns. This may improve the efficiency of data communication.

The shared data 221 and 231 can be data files, they can be partial data files or the shared data can be data especially composed for the purpose of differential compression. In an embodiment it may be assumed that the base data sets are not mutable. This means that e.g. Merkle trees may offer a very convenient method for generating a digest structure for a data set. The data set (assuming a large file) then has a single hash value that uniquely identifies the data set in question. Moreover, it is possible to apply the Merkle tree procedure using different block sizes (fixed or varying) for the same data set. Thus we can represent elements of the same data set using compact labels. This may further improve the efficiency of data communication.

The manager component 240 can be the same as a content server or a web site or it can be a different element like a proxy. The manager component may be located on the network (Internet), it may be provided by a Content Distribution Network (CDN) or it may be provided by a large web site (OVI, Facebook, etc.). The manager 240 may be the source of the bulk loaded data. It may accepts frequency data as input and as a response to the frequency data, it may output digest structure or hash tree information. It is possible to use the system without this manager component 240, however, employing the activity information or the usage patterns may increase performance of the system.

The manager component may not be directly involved in the communications. If a data set whose hash value is not recognized is met, the manager can be consulted. The manager can also be informed (by servers or clients) about how well a given chunking partitioning (digest structure or hash tree) works and give feedback to create better partitions. A server can do this also without the manager by simply creating a new digest structure or hash tree and instructing the client how to construct it based on the existing data set.

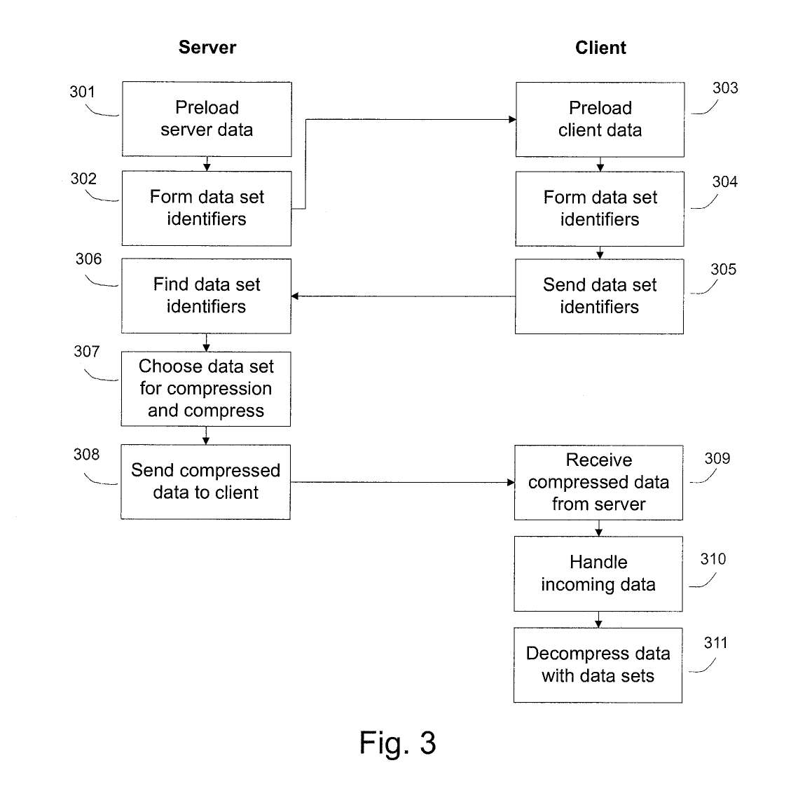

FIG. 3 displays a method according to an embodiment of the invention. In 301, the server receives preloaded data for use in the compression and in 302 data set identifiers (digests) are formed for use at the server. In 303, the client receives preloaded data for use in the compression and in 304 data set identifiers (digests) are formed for use at the client. In FIG. 3, the phases 301-304 have been presented in an order, but they may happen in practically any order. In 305, the client then sends the data set identifiers or digests along with a possible accompanying request for other information to the server. In 306, the server finds the data set identifier or digests that correspond to the data sets in its memory. The server then chooses 307 the data set for use in the compression and uses that data set to compress the data for sending to the client. The compressed data is then sent 308 to the client that receives 309 the compressed data from the server. The client handles 310 the incoming data and decompresses 311 the data using the data sets that are referred to in the transmission from the server.

Existing synchronization and caching techniques may be improved by employing a negotiation phase in data communications that is used to identify bulk data sets loaded by a client beforehand. The knowledge of the bulk data sets are then used to optimize communications. A special signature or digest or hashing scheme is used to identify parts of a bulk data set. In the negotiation phase the client informs server about supported data sets. These data sets may be chosen by the client for example on the basis of a MIME type used in communication or in another way that enables the use of the type of the data being communicated. The server may then be allowed to choose a selection of the data sets for the differential compression.

The client may inform the server about the data sets it supports and thus the server can then decide which one to use and send the compressed data. The representation for the compression can use any of a number of compression techniques, including delta compression by simply referring to parts of the bulk data set. Since referring to a part of a document will require at least a pointer and a size field, it is expected that there is a minimum required length for the elements to be considered for delta compression. One simple approach is to simply divide the file into blocks of a fixed size and then compute the signatures or digests of hashes.

According to an embodiment of the invention there is also offered a protocol for exchanging information on multi-level hash representations or hash trees. The digests or hashes are composed into a multi-level acyclic representation, or a tree, and the composition of the trees can effectively be communicated from the server to the client or vice versa.

According to an embodiment of the invention, the shared data sets for the client and the server are based on the profile of the user of the client. The data can be operating system files, software, multimedia data such as music, video or images, cached web sites and web content, or any other data. These data sets are then installed to the server and to the client. They are partitioned, signatures or digests are formed for the partitions either before or after installation, and the digests or signatures are formed into a multi-level structure of digests or hashes. In this multi-level structure or tree, at least two signatures or digests or hashes are combined and a parent digest is computed for them. This parent digest may be formed using a Merkle tree, and the parent digest may be used to identify the data sets. The parent digest may then be used in the communication enabling differential compression.

The data sets may also be updated using the same compressed data communications according to an embodiment. The existing data set can be used to send and receive differentially compressed updates to the server and the client. The update data may be partitioned in chunks. An algorithm may be used to find non-changed chunks to shared data (hash lookup). An algorithm may also find shared chunks that need minimal changes and those chunks may be updated separately.

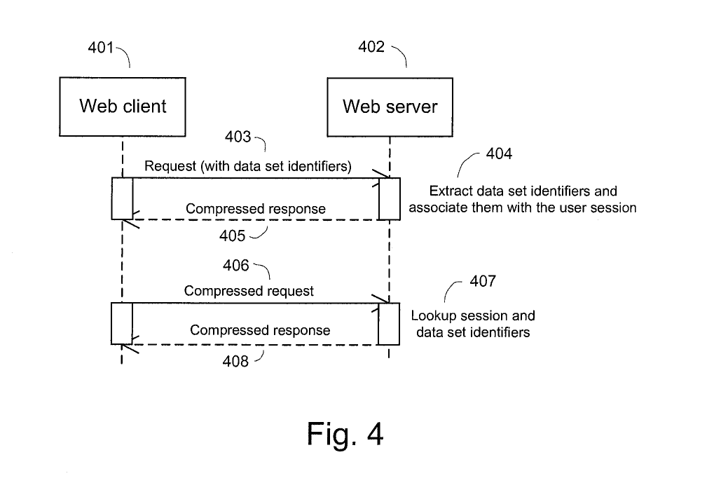

FIG. 4 displays devices and a system as well as its operation in web browsing according to an embodiment of the invention. A web client 401 and a web server 402 are engaged in communication to enable a web browsing session by the user of the web client 401. The web client 401 sends a request 403 with data set identifiers (digests) to the server 402. The web server 402 extracts the data set identifiers from the request and associates them with the current user session 404. After that, the server uses the data set identifiers to compose a compressed response as has been explained earlier, and sends a compressed response 405 back to the client. The client can now use the compressed response 405 to construct the full response to the request and display the results to the user of the web client. In a subsequent compressed request 406 from the client the existing data sets are employed. The server performs 407 a lookup for the session data set identifiers (digests) and sends back a compressed response 408 to be used by the client in constructing a full response to be displayed to the user.

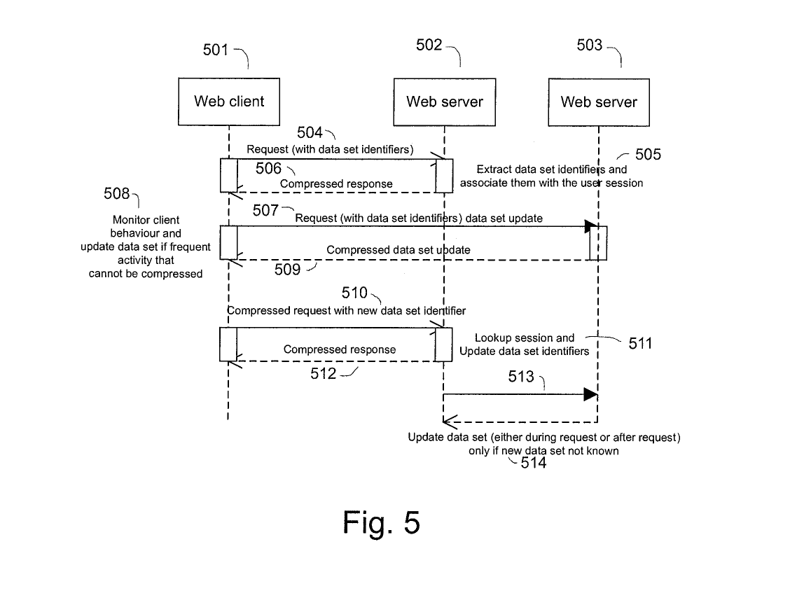

FIG. 5 displays devices and a system as well as its operation in web browsing according to an embodiment of the invention. A web client 501, a web server 502 and a web server 503 are engaged in communication to enable a web browsing session by the user of the web client 501. The web client 501 sends a request 504 with data set identifiers (digests) to the server 502. The web server 502 extracts the data set identifiers from the request and associates them with the current user session 505. After that, the server uses the data set identifiers to compose a compressed response as has been explained earlier, and sends a compressed response 506 back to the client. The client can now use the compressed response 506 to construct the full response to the request and display the results to the user of the web client. The client behavior is now monitored 508 to detect use patterns and to identify situations where a data set is frequently needed but is not available for compression, in other words, requests from the server whose reply cannot be compressed or cannot be compressed efficiently. In response to the monitoring 508, which can take place at the client or at the server, the client can request a data set update from the web server 503 using a data set update request 507 with data set identifiers. The server 503 may now send back a compressed data set update to improve the available data sets at the client. The client may now use the improved data sets and new data set identifiers or digests to send a compressed request 510 to the server 502. The server may carry out a lookup 511 and it may update the session data set identifiers or digests that the client has, and send back a compressed response 512. If necessary, that is, if the server 502 does not hold the new data set that the client now possesses, the server 502 may request 513 a data set update from the server 503 and the server 503 may then send back a data set update 514 to the server 502.

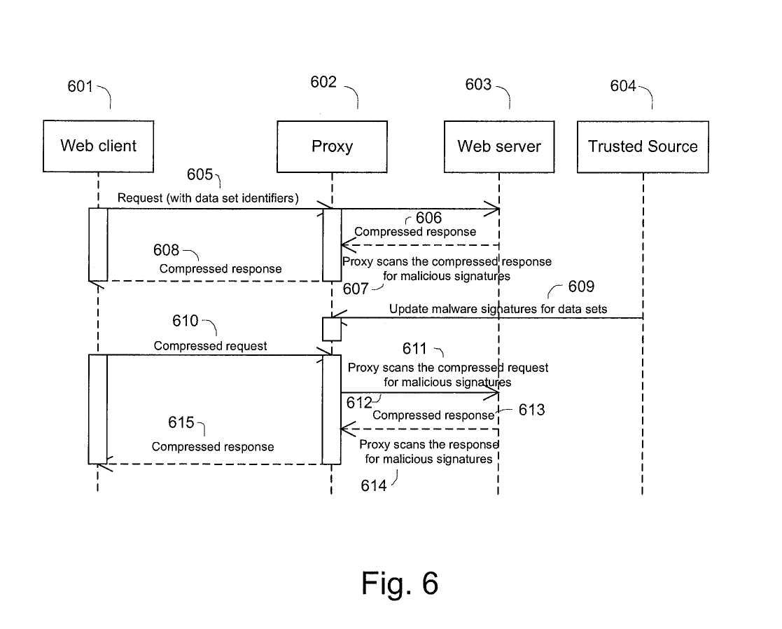

FIG. 6 displays devices and a system as well as its operation in secure web browsing according to an embodiment of the invention. A web client 601, a proxy 602, a web server 603 and a trusted source 604 are engaged in communication to enable a web browsing session by the user of the web client 601. The web client 601 sends a request 605 with data set identifiers (digests) to the server 603 via the proxy 602. As explained earlier, the web server sends back a compressed response 606. The proxy now scans 607 the compressed response, especially the signatures or digests for malicious signatures. If the proxy finds the compressed response to be safe it forwards 608 the compressed response to the client 601, otherwise it prevents the sending of malicious digests to the client. For this scanning to happen effectively, the trusted source 604 may send updates 609 of the malware signatures to the proxy 602. In a further operation, the web client 601 sends a compressed request 610 with data set identifiers (digests) to the server 603 via the proxy 602. The proxy 602 may now scan 611 the request for malware signatures or digests, and forward 612 the request if it is clean. The server 603 may now send a compressed response 613, again to be scanned 614 by the proxy 602 and to be forwarded 615 to the client 601 if it has been determined to contain no malware signatures or digests.

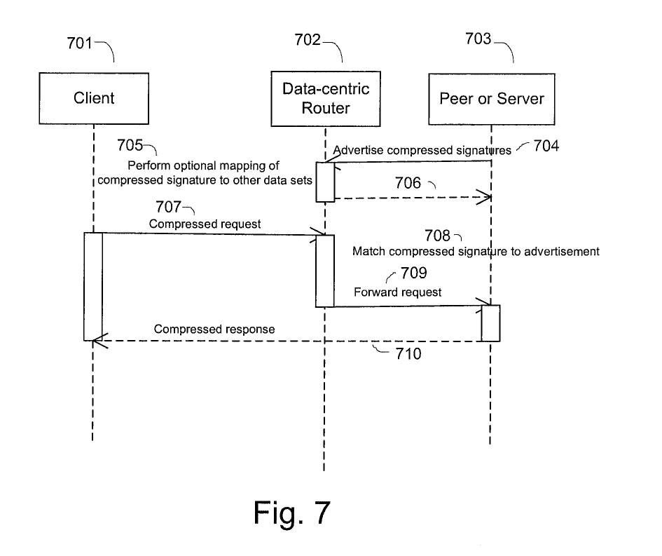

FIG. 7 displays devices (a client 701, a router 702, and a peer/server 703) in communication according to an embodiment of the invention. Prior to a request for data by the client 701, the peer or server 703 may advertise 704 the compressed signatures or digests it supports to the data-centric router 702. The router 702 may perform mapping 705 of the compressed signatures to other data sets and send a response 706 back to the peer/server. When the client 701 now sends a compressed request 707 to the network through the router 702, the router matches 708 the compressed digest sent by the client to the advertised digest by the peer/server 703. The router then forwards 709 the request to the peer/server 703, which may send back a compressed response 710 to the client 701.

It is to be understood that the above embodiments of the invention can also be combined, For example, the web browsing scheme of FIG. 4 may also employ a data centric routing scheme according to FIG. 7. Further, any of the embodiments may employ an element capable of malware detection according to FIG. 6.

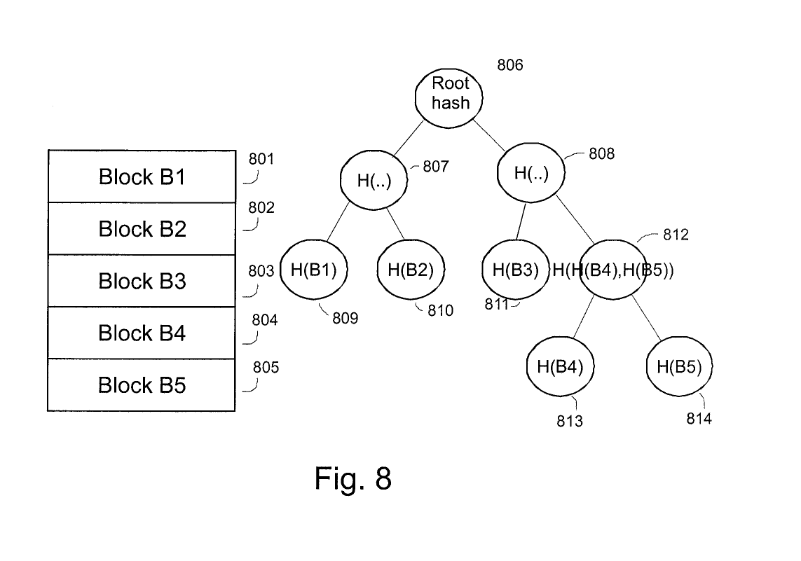

FIG. 8 displays a digest or a hash structure according to an embodiment of the invention. The data blocks 801-805 may be used to form digests or signatures for the data blocks (809, 810, 811, 813, 814) using for example a hash function H. A further digest 812 or hash may be formed for at least two of the digests, for example the digests 813 and 814. One way of forming the digest is to concatenate the digests 813 and 814 and to compute a new hash value 812 for the concatenation. Further hash values 807 and 808 may be computed in a similar manner. A parent digest or a root hash 806 may be formed from the child digests 807 and 808 of the parent digest 806. The hash functions can be, for example, SHA-1 hashes (Secure Hash Algorithm). SHA-1 is widely used in security applications and protocols. It produces 160-bit digests. Other types of digests and different lengths of digests are of course possible.

The digests or signatures for the data chunks can be computed in a hierarchical fashion, for example by using a Merkle tree. Then the signatures can be checked (top-down) against the bulk data, for example using hash table lookup. This requires that the bulk data has a hash table-based lookup index. This is a reasonable requirement and will result small delta compression overhead due to first computing the hashes or a hash tree, and then doing constant-time lookups.

A Merkle tree is a complete binary tree that has a hash function h and an assignment O. The function h is a one-way hash function such as SHA-1. O maps the set of nodes to the set of k-length strings: n→O(n) belongs to {0,1}k. For any interior node, nparent the assignment φ must satisfy φ (nparent)=h(φ(nleft)∥φ(nright)). The value of φ(I) for a leaf node I can be chosen arbitrarily. It is clear that this construction can be extended to cover trees that have more children than two.

In a practical implementation, a Merkle-tree based construction can be used to represent the delta signatures or the data chunk digests. Merkle-trees are meaningless unless the sender and receiver have the same bulk data set as a common reference. Therefore, they have intrinsic security properties. Merkle trees can be applied to a data set (file) to partition it into fixed or variable sized chunks and then derive a common hash label for the whole data set. The partitioning can be based on an expected update frequency (some types of data may be such that they are typically modified more often than others). The hash tree can cover a part of the file, a whole file, parts of at least two files or parts and wholes of at least two files. Merkle tree gives a way to distinguish between data sets and refer to certain parts of a data set. Merkle trees can also be used to verify data during the loading of a data set.

Merkle trees offer to generate a number of partitions for a large data set and derive a very compact representation for them. The motivation is that it may turn out that a new access distribution is identified that emphasizes certain larger sequential data blocks in the file. Now, we can simply generate a new Merkle tree that has this more frequent data as an atomic block, we generate a new hash root value which uniquely identifies this new “skeleton” for the data set. It is now sufficient to simply update the clients with his new tree (update the block size algorithm). This offers flexibility.

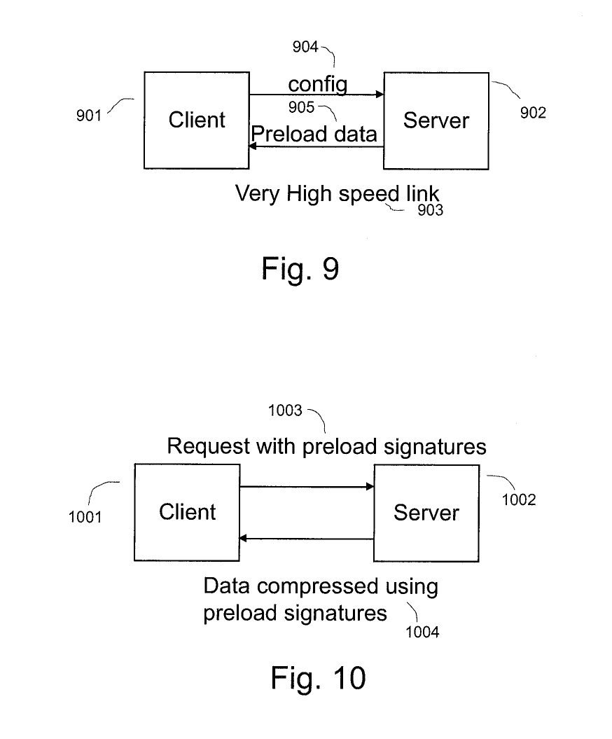

FIG. 9 presents a simplified diagram of data bulk loading according to an embodiment of the invention, in which massive amounts of data are transferred from a server 902 to the client device 901. The data set has a set of signatures associated with the data set. FIG. 9 illustrates this bootstrap phase. The client 901 sends configuration data 904 to the server and the bulk loading 905 of preload data is done accordingly. The bulk loading can happen when shipping a device or by a user after buying the device. The bulk loading can be specific to a device type. In the case that the user performs the bulk loading after buying the device, it is possible to bulk load based on user preferences. The first uploading 905 of the files may be done using a very fast connection 903 e.g. during the flashing of the device or before the device is sold to a customer, or at least using a fast internet connection.

FIG. 10 shows a simplified embodiment of the invention. In this embodiment, massive data preloading to devices with mass storage modules is utilized in order to later use this preloaded information in optimizing data transmission size (and thus cost, delay, energy efficiency). The client 1001 informs a content server 1002 about the data set (or sets) in use. This is done by adding the data set signatures (digests) to the request 1003. Or correspondingly, a server can identify the data sets used to compress a document using metadata elements. FIG. 10 illustrates this process in which client requests data from a content server and informs the server that a certain bulk data set is available on the client. The server then, if it supports the identified bulk data set, will utilize it to compress the data and send back a compressed response 1004. The negotiation data can be passed in, say, HTTP headers.

Practically, the embodiment of the invention may happen as follows. The client 1001 sends root hashes of the data sets to the server. The data sets may be application specific (one for messaging, another one for office documents, etc.). The mapping can be done automatically based on, for example, MIME type. It is also possible to send a Bloom filter (probabilistic data set) that covers all the supported root hashes (data set identifiers). With a Bloom filter, it is possible to detect whether a certain root hash is supported by the client 1001 or not without sending all the root hashes as values themselves in the communication to the server 1002. The server 1002 then checks whether or not the data set is supported. If not, then normal operation according to state of the art technologies is assumed (normal HTTP transmission, for example). If data set is supported, the server 1002 sends a differentially compressed version of the data to the client 1001. This can be based on a single data set or multiple data sets. The server can perform the differential compression beforehand or it can be done on the fly. When the client 1001 receives the differentially compressed data, it can reconstruct the original data by looking up the chunks (and parts of chunks) from the local data sets involved, using the digests sent in the server response 1004.

Differential compression enables the server to send to the client only the data that are different from what exists at the client already. If the client already has data chunks that allow it to build most of the data that the server are transmitting, the server will detect this and not send those parts. The server sends the client the data that the client does not have and instructions on how to update the data that the client already has. The client can then reconstruct the data although all data are not sent from the server to the client. The forming of the differential information can happen on the fly or it can be precomputed before the client requests the data.

The hashes or digests can be communicated using HTTP headers as follows. The TE request-header field in the HTTP 1.1 protocol indicates what extension transfer-codings the client is willing to accept in the response.

### Example of a Client-Request HTTP Header:

GET /video.mpg HTTP/1.1
Host: www.example.com
TE:differential;ids=230c1b958ba91ab37a68f965818b8d74
a8b171fb

The client sends a request to the server using the GET operation of the http protocol. The host name www.example.com is indicated in the Host section of the request. Above, TE stands for transfer encodings and is used to indicate the type of compression the client supports. The TE field includes the SHA-1 hashes of the data sets.

### Example of a Server Response:

HTTP/1.1 200 OK
Date: Mon, 23 May 2006 20:30:00 GMT
Server: Apache/1.3.3.7 (Unix) (Red-Hat/Linux)
Last-Modified: Wed, 01 Jan 2001 10:10:00 GMT
Accept-Ranges: bytes
Content-Length: 64000
Connection: close
Transfer-Encoding: differential
Content-Type: video/mpeg
<differentially encoded content, the changes
are identified with respect to the datasets
offered by the client>

The server responds by sending the 200 OK message to the client, indicating a successful request. This is followed by information of the server, date and time information and content description. The TE field (transfer encoding) indicates that a differential compression is used. The content-type field shows which type of content is in question. The transmitted data is, in the above example, differentially encoded content, where information of the necessary changes with respect to the client datasets are sent.

In delay tolerant or delay-enabled operation, the client delays the transmission of messages in order to wait for similar kinds of messages in order to decrease networking and processing costs. Similarly, the server may delay the sending of a message in order to accumulate more data that can be compressed. For the client, this is mostly useful for applications that generate a lot of non-interactive requests to servers that do not require immediate feedback (for example, document editing). This feature can be indicated in the HTTP header so that server will know that the client supports this.

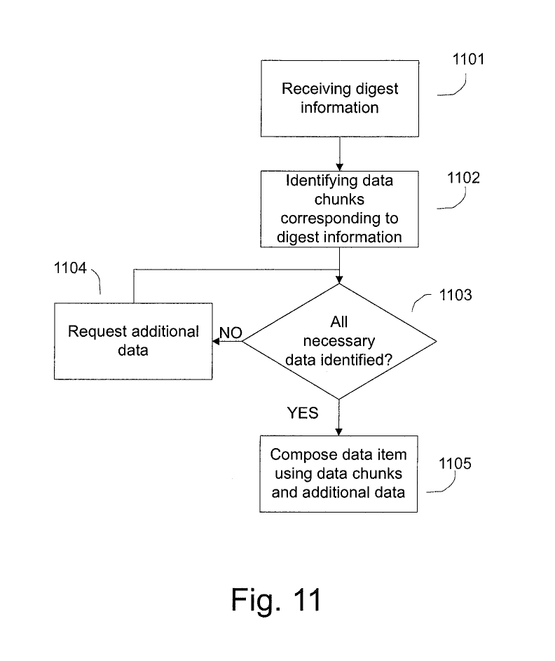

FIG. 11 displays operation of a device and a method for a device according to an embodiment of the invention. In the method, digest information is received 1101 at the device. This digest information is used to identify 1102 data chunks corresponding to digest information and accessible by the device (or stored at the device). Next, it is checked 1103 whether all necessary data has been identified for the construction of the desired data item. If not, then additional data may be requested 1104. When all necessary information exists to identify data chunks needed for the construction of the desired data item, the data item is composed 1105 of the data chunks identified.

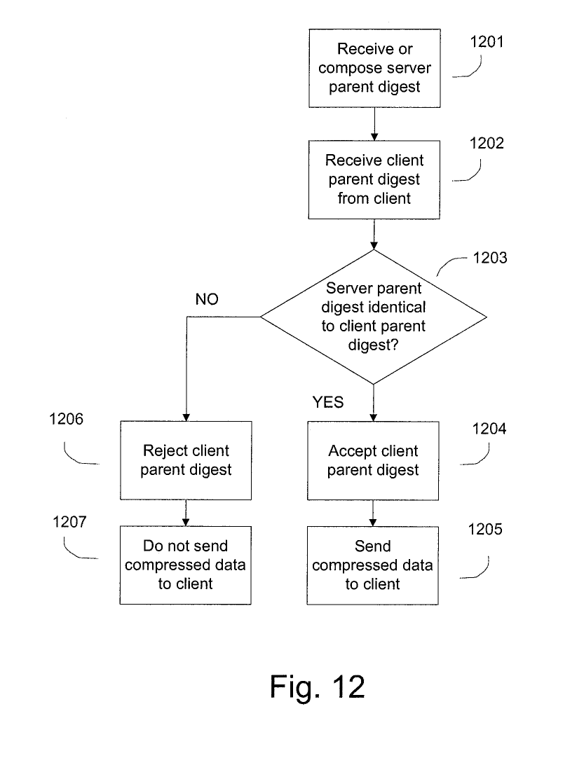

FIG. 12 displays operation of a device and a method for a device according to an embodiment of the invention. In the method, a server parent digest for the data chunks is composed or received 1201 e.g. at the server. A client parent digest from the client is received 1202 e.g. from the client. The server parent digest is then compared 1203 to the client parent digest to determine whether they are identical. If the parent digests are identical, the client parent digest is accepted 1204 and compressed data is sent 1205 to the client. If the parent digests are not identical, the client parent digest is rejected 1206 and compressed data is not sent 1207 to the client.

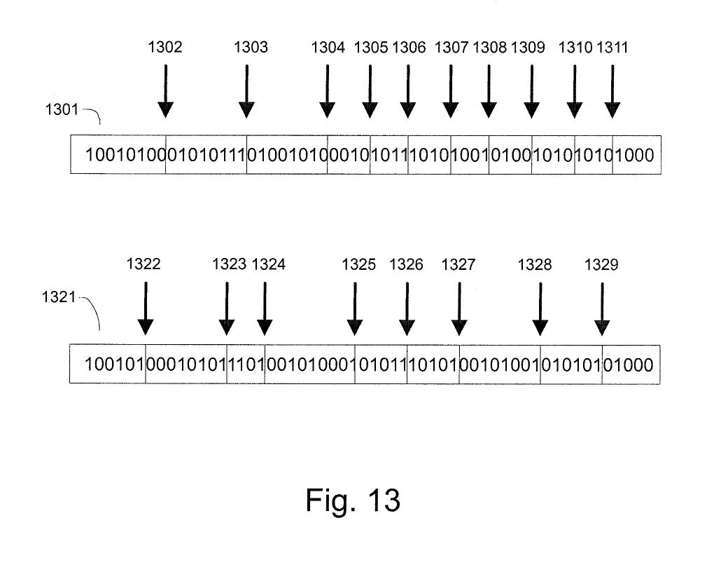

FIG. 13 shows some methods for chunking data in order to form digests or signatures for the data chunks. The data 1301 is partitioned to chunks using a partitioning function that performs the partitioning irrespective of the data being partitioned. The function has formed three partitions of length 8 by defining cut points 1302, 1303 and 1304 for the data. The function has then formed eight partitions of length 4 by definining cut points 1304-1311 for the data. The latter cut points may have been defined, e.g. after modifying the data partitioning function based on the frequency of access of the data. It may be, e.g., that the latter part of the data 1301 has been accessed more frequently or less frequently than the former part. This allows a representing those data that are frequently transmitted more compactly. The data 1321 has been partitioned using a data partitioning function that carries out the partitioning based on the data. This partitioning function has partitioned the data so that each of the data chunks contain three “1”s except the last chunk. There may be many other functions that depend on the data and allow highly sophisticated ways of partitioning the data. Whether the partitioning of data is done as is done for the data 1301 or for the data 1321, the result of the partitioning needs to be unambiguously derivable by the server and the client. They may, e.g., use the same fixed-length partitioning function, or they may inform each other in some other way about the partitioning to be used. Accordingly, they may inform each other to construct new hash trees using a certain function and the existing data sets. The optimal size of chunks depends on the data and the usage patterns. It is possible to have a plurality of chunking strategies for the data set, each of them corresponding to an acyclic digest graph (a hash tree) with a single parent digest (root hash) value. One can be a fixed size chunking. Other one could be based on a windowing technique. When certain blocks and sequences of blocks are requested frequently, it is possible to reflect this usage behavior in the chunking and generate a new hash tree that, for example, combines blocks to better reflect the patterns.

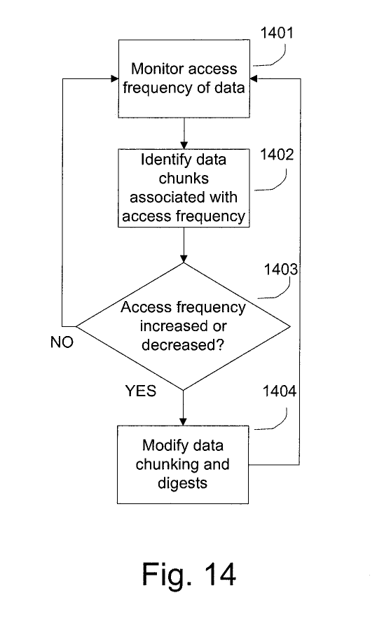

FIG. 14 displays operation of a device and a method for a device according to an embodiment of the invention. The access frequency of data is monitored 1401. Based on this access frequency of data, the data chunks making up the data and the related digests are identified 1402. If the access frequency has increased or decreased 1403, in other words, if the access frequency deviates from the expected or the mean value, the data chunking and corresponding data digests or hash values and the parent digests or root hashes may be modified 1404. This may involve changing the function based on frequency of access. For example, increasing the chunk size if there is frequent access or decreasing the chunk size if there is frequent access may be ways of modifying the function. It may be necessary to inform the other parties to update the data set and to construct new hash trees if modifications have been made. After that, the monitoring 1401 continues. The monitoring may be constant, i.e. very frequent, or the updates may be carried out seldom after significant amount of access data has been cumulated.

Various ways of implementing various embodiments in a practical setting are possible. Different embodiments can be implemented as an add-on for current Internet content delivery protocols. The data sets and digests can be identified in a header of a protocol, such as the HTTP or SIP header, thus making it possible to deploy the system in a transparent fashion. The data being delivered in between two devices (peer-to-peer, server-to-client, network element to network element) may for example be video, music, images, maps, user files, calendar information, visual presentations, books and articles and spreadsheets. Web browsing, e.g. using the same content many times, a popular website or a popular set of images may use an embodiment as presented earlier. Various embodiments may be applicable for verifying the data for malware. Applications for delivering data and software in cloud computing environment, computing results and input data for computing may be useful. The embodiments may be used in bittorrent-like data deliveries where data is coming from a number of sources to a single client or broadcasts where data is being sent from a single source to multiple recipients. Streaming data can be also supported, but it may require that the signatures (and delta coding) is done in real-time. Applications in compression of any messages transmitted between two devices or inside devices may be found. Ways for data clustering based on commonalities in data may be offered, since this happens automatically due to identifying the data sets. Subscription services for updates (e.g. software updates and distribution) may be offered. Virus and malware scanning based on differentially compressed updates using cloud services may be done. If the OS and libraries are shared with the cloud service, modifications to OS and libraries may be checked. The security service may maintain a set of suspicious update signatures and how the update message will look.

The various embodiments of the invention can be implemented with the help of computer program code that resides in a memory and causes the relevant apparatuses to carry out the invention. For example, a terminal device may comprise circuitry and electronics for handling, receiving and transmitting data, computer program code in a memory, and a processor that, when running the computer program code, causes the terminal device to carry out the features of an embodiment. Yet further, a network device may comprise circuitry and electronics for handling, receiving and transmitting data, computer program code in a memory, and a processor that, when running the computer program code, causes the network device to carry out the features of an embodiment.

It is obvious that the present invention is not limited solely to the above-presented embodiments, but it can be modified within the scope of the appended claims.

1.-20. (canceled)

21. A method for data transmission at an apparatus using a first data connection, comprising:
forming at least a first client data chunk and a second client data chunk in the memory of the apparatus, wherein the first client data chunk corresponds to a first server data chunk and the second client data chunk corresponds to a second server data chunk,
forming a first client digest for the first client data chunk in the memory of the apparatus,
forming a second client digest for the second client data chunk in the memory of the apparatus,
forming a parent client digest indicative of the first client digest and the second client digest in the memory of the apparatus,
sending the parent client digest to a server,
in response to the sending of the parent client digest, receiving instructions from the server for forming a first client data item using the first client data chunk and the second client data chunk,
forming the first client data item in the memory of the apparatus using the first client data chunk and the second client data chunk.

22. A method according to claim 21, further comprising:
selecting the first client data chunk using a chunk selection function, wherein the chunk selection function is common for the server and the client.

23. A method according to claim 21, further comprising:
making the first client data chunk and the first server data chunk correspond to each other over a second data connection prior to receiving the parent client digest at the server, wherein the second data connection is faster than the first data connection.

24. A method according to claim 21, further comprising:
forming a plurality of parent client digests using a plurality of client digests in the forming of each parent client digest, and
sending the plurality of parent client digests to the server using a digest negotiation protocol.

25. An apparatus comprising a processor, memory including computer program code, the memory and the computer program code configured to, with the processor, cause the apparatus to perform at least the following:
form at least a first client data chunk and a second client data chunk in the memory of the apparatus, wherein the first client data chunk corresponds to a first server data chunk and the second client data chunk corresponds to a second server data chunk,
form a first client digest for the first client data chunk in the memory of the apparatus,
form a second client digest for the second client data chunk in the memory of the apparatus,
form a parent client digest indicative of the first client digest and the second client digest in the memory of the apparatus,
provide the server with access to the parent client digest,
in response to the providing of the access to parent client digest, receive instructions from the server for forming a first client data item using the first client data chunk and the second client data chunk,
form the first client data item in the memory of the apparatus using the first client data chunk and the second client data chunk.

26. An apparatus according to claim 25, further comprising computer program code configured to, with the processor, cause the apparatus to perform at least the following:
select the first client data chunk using a chunk selection function, wherein the chunk selection function is common for the server and the client.

27. An apparatus according to claim 26, further comprising computer program code configured to, with the processor, cause the apparatus to perform at least the following:
monitor the access of the first client data chunk to form first access monitoring information, and
modify the chunk selection function based on the first access monitoring information.

28. An apparatus according to claim 27, further comprising computer program code configured to, with the processor, cause the apparatus to perform at least the following:
modify the chunk selection function to select larger chunks if the access monitoring information indicates frequent access.

29. An apparatus according to claim 25, further comprising computer program code configured to, with the processor, cause the apparatus to perform at least the following:
making the first client data chunk in the memory of the apparatus and the first server data chunk correspond to each other over a second data connection prior to receiving the parent client digest at the server, wherein the second data connection is faster than the first data connection.

30. An apparatus according to claim 25, further comprising computer program code configured to, with the processor, cause the apparatus to perform at least the following:
compute the first client digest, the second client digest and the parent client digest using a hash function, and
form a directed acyclic graph representation of the first client digest, the second client digest and the parent client digest.

31. A method for data transmission at an apparatus using a first data connection, comprising:
forming at least a first server data chunk and a second server data chunk, wherein the first server data chunk corresponds to a first client data chunk and the second server data chunk corresponds to a second client data chunk,
forming a first server digest for the first server data chunk in the memory of the apparatus,
forming a second server digest for the second server data chunk in the memory of the apparatus,
forming a parent server digest indicative of the first server digest and the second server digest in the memory of the apparatus,
receiving a parent client digest originating from a client,
comparing the parent client digest and the server client digest,
in response to the comparing, providing the client with access to instructions for forming a first client data item using the first client data chunk and the second client data chunk.

32. Method according to claim 31, further comprising:
forming a plurality of parent server digests using a plurality of server digests in the forming of each parent server digest, and
receiving a plurality of parent client digests originating from a client using a digest negotiation protocol.

33. A method according to claim 31, further comprising:
selecting the first server data chunk using a chunk selection function, wherein the chunk selection function is common for the server and the client.

34. A method according to claim 31, further comprising:
monitoring the access of the first server data chunk to form first access monitoring information, and
providing access to the first server data chunk for the client based on the first access monitoring information.

35. An apparatus comprising a processor, memory including computer program code, the memory and the computer program code configured to, with the processor, cause the apparatus to perform at least the following:
form at least a first server data chunk and a second server data chunk, wherein the first server data chunk corresponds to a first client data chunk and the second server data chunk corresponds to a second client data chunk,
form a first server digest for the first server data chunk in the memory of the apparatus,
form a second server digest for the second server data chunk in the memory of the apparatus,
form a parent server digest indicative of the first server digest and the second server digest in the memory of the apparatus,
receive a parent client digest originating from a client,
compare the parent client digest and the server client digest,
in response to the comparing, provide the client with access to instructions for forming a first client data item using the first client data chunk and the second client data chunk.

36. An apparatus according to claim 35, further comprising computer program code configured to, with the processor, cause the apparatus to perform at least the following:
select the first client data chunk using a chunk selection function, wherein the chunk selection function is common for the server and the client.

37. An apparatus according to claim 36, further comprising computer program code configured to, with the processor, cause the apparatus to perform at least the following:
monitor the access of server data to form first access monitoring information, and
modify the chunk selection function based on the first access monitoring information.

38. An apparatus according to claim 35, further comprising computer program code configured to, with the processor, cause the apparatus to perform at least the following:
form a plurality of parent client digests using a plurality of client digests in the forming of each parent client digest, and
send the plurality of parent client digests to the server using a digest negotiation protocol.

39. An apparatus according to claim 38, further comprising computer program code configured to, with the processor, cause the apparatus to perform at least the following:
form the plurality of parent client digests comprising a first parent client digest and a second parent client digest, wherein both the first parent client digest and the second parent client digest relate to the first client data item, and
use at least partly different client digests in the forming of the first parent client digest than in the forming of the second parent client digest.

40. An apparatus according to claim 35, further comprising computer program code configured to, with the processor, cause the apparatus to perform at least the following:
compute the first server digest, the second server digest and the parent server digest using a hash function, and
form a directed acyclic graph representation of the first server digest, the second server digest and the parent server digest.
